(19) United States
(12) Patent Application Publication
(10) Pub. No.: US 2025/0033408 A1
(43) Pub. Date: Jan. 30, 2025

(54) MECHANICAL ASSEMBLY TO DISENGAGE A BICYCLE REAR HUB WITH A PAWL AND RATCHET-RING CLUTCH MECHANISM

(71) Applicant: Jose Hsu, Surrey (CA)

(72) Inventor: Jose Hsu, Surrey (CA)

(21) Appl. No.: 18/781,387

(22) Filed: Jul. 23, 2024

(30) Foreign Application Priority Data
Jul. 29, 2023 (CA) 3207911

(51) Int. Cl. B60B 27/02; B60B 27/04

(52) U.S. Cl. CPC B60B 27/023; B60B 27/047

(57) ABSTRACT

This invention modifies a common bicycle pawl and ratchet clutch to decouple the pawls from the ratchet so that the wheel is not able to drive the drive-train in a reverse direction, and the hub does not ratchet when freewheeling. The mechanical assembly consists of a cam plate that attaches to a freehub that hosts a plurality of sprung pawls, where the cam plate actuates the pawls as followers, and where the cam plate is also attached to a cylindrical member by a plurality of coiled members through one of their protruding ends, having a static friction against rotation relative to the cylindrical member they coil onto, and the cylindrical member is axially and rotary fixed relative to the all of the parts comprising the assembly.

### FIELD OF INVENTION

This invention relates to bicycle hubs in general. More specifically, this invention allows the forwards transfer of drive torque from the drive-train to the rear wheel, while decoupling the drive-train from the rear wheel, to allow the wheel to rotate forwards and in reverse directions relative to the drive-train.

### INTRODUCTION/BACKGROUND OF THE INVENTION

The vast majority of traditional bicycle hub clutch assemblies comprise mainly of a plurality of sprung pawls that ratchet around a toothed ring, known as the ratchet-ring to a person having ordinary skill in the art, where the ring is hosted in the driven portion of the hub, to which the rear wheel attaches, and the sprung pawls are hosted in the torque driving portion of the hub, to which the drive-train attaches. A common characteristic of these clutch assemblies is the ratcheting sound from the pawls when the bicycle is traveling forwards while the user is not pedaling. This ratcheting sound is a byproduct of the pawl and ratchet-ring formed clutch assembly within the bicycle hub. The clutch assembly main function is to allow the disengagement of the drive-train from the rear wheel, when the rear wheel rotates in the forwards direction relative from the drive-train, preventing the rear wheel from back driving the drive-train in the forwards direction. The end result is the bicycle user being able to stop pedalling and initiate freewheeling while moving forwards.

The ratcheting clutch assemblies such as described in these inventions: U.S. Pat. Nos. 5,143,189A, 9,676,233B1, US20230150304A1, and other prior art of the variations of traditional pawl and ratchet-ring clutch assemblies have a common characteristic of not disengaging the driving portion of the hub from the driven portion in the instance where the driven portion rotates backwards relative to the driving portion. This characteristic is a direct outcome from the automatic one-way clutch ratcheting characteristic of these assemblies; as the ratcheting originates from the sprung pawls being positioned in an interference position against forward rotation of the pawl relative to the ratchet-ring at every tooth displacement the pawls travel through of the ratchet-ring, during its reverse rotation relative to the ratchet-ring. The end result is the reverse rotation of the bicycle wheel rotating the pedals in reverse.

Recreational cycling sports have, in recent times, introduced the demand for the ability and convenience to decouple the drive-train from the wheel to allow the wheel to rotate in reverse relative to the terrain and drive-train; as well as a preference towards a quiet freewheeling when coasting in the forwards direction, a characteristic only possible from non-ratcheting clutch assemblies.

The proposed invention allows a pawl and ratchet-ring clutch assembly to decouple the drive-train from the wheel, in the reverse wheel rotation, as well as non-ratcheting freewheeling.

### SUMMARY OF THE INVENTION

The proposed invention of a mechanical assembly integrates onto existing pawl and ratchet-ring clutch assemblies by adding a simple and low profile secondary clutch to the driving portion of the hub, or freehub, that actuates based on the direction of rotation of the freehub, with its attached drive-train, relative to the hub main axle.

Where one direction retracts a single or plurality of sprung pawls away from the ratchet-ring, this ratchet-ring hosted in the driven portion of the hub, or hubshell, so that the pawls are not able to ratchet and re-position into an interference position against forward rotation of the pawls relative to the ratchet-ring; and the other direction releases and guides the pawls back to an interference position against forward rotation of the pawl relative to the ratchet-ring.

The preferred embodiment consists of plurality of wound springs, or coiled members, coiled over a sleeve or cylindrical member. The cylindrical member is fixed axially and rotary to the hub main axle connected to the bicycle frame. The coiled members are also attached, at one protruding end, to a cam plate which is axially fixed onto the freehub. The cam plate actuates the pawls attached to the freehub as followers, and is allowed to rotate in both directions for a determined angle, relative to the freehub, to actuate the pawls to two positions: a retracted pawls position in one direction, and a released pawls position on the other direction which extend the pawls back in contact with the ratchet-ring. The cam plate's plurality of cam slots has an interference with the pawls at the end of each position, preventing further rotation of the cam plate relative to the freehub once each position is reached, which sets the total angle of rotation the cam plate is allowed to do relative to the freehub in each direction. The coiled members, attached to the cam plate at one end, have a static friction against rotation relative to the cylindrical member they coil onto, and act as the support against rotation for the cam plate when the freehub rotates relative to the cylindrical member fixed axially and rotary to the hub main axle.

At the end of each position between the allowed rotation of the cam plate relative to the freehub, further rotation of the freehub drives the coiled members through the cam plate to overcome static friction of their coiling to the cylindrical member, where the coiled members start rotating relative to the cylindrical member by surface-sliding, and where the freehub now rotates together with the cam plate and coiled members. The coiled members are right hand wound and have a higher static friction on the wound direction. This wound direction coincides with the direction of rotation of the freehub relative to the cam plate that releases the pawls to extend back in contact with the ratchet-ring.

The static friction against rotation of the coiled members to the cylindrical member is relatively low in both directions, and just enough to allow the determined angle of rotation between the cam plate and the freehub before the static friction is overcome. Once its overcome, the lower value kinetic fiction from the coiled members sliding does not have a significant addition to the torque required for the drive-train to move the wheel in the forwards direction.

The proposed invention allows ability to disengage the drive-train from a pawl and ratchet-ring clutch assembly, through a rotational reverse input of the drive-train, so that the pawl and ratchet-ring clutch assembly stops ratcheting and preventing a reverse rotation of the wheel, attached to the hubshell, to drive the drive-train in a reverse rotation; as well as engaging the drive-train to the hubshell through a rotational forward input of the drive-train relative to the hubshell.

To further understand the proposed invention, the following detailed description of a preferred embodiment in conjunction with accompanying drawings will make the invention more apparent.

### BRIEF DESCRIPTION OF THE DRAWINGS

Referring to the figures attached to this document which form a part of this original disclosure:

FIG. 1 shows a perspective view of an embodiment of a bicycle rear hub, in which the preferred embodiment of the disclosed invention is hosted within.

FIG. 2 shows the separated component groups of an embodiment of the bicycle rear hub by their primary functions and relative rotation.

FIG. 3a shows an exploded view of the components of the preferred embodiment of the invention.

FIG. 3b shows another perspective of the exploded view found in FIG. 3a.

FIG. 4a shows a partially exploded view of the components of the preferred embodiment of the invention within an embodiment of a bicycle rear hub with a pawl and ratchet-ring clutch mechanism.

FIG. 4b shows another perspective of the exploded view found in FIG. 4a.

FIG. 5a shows the preferred embodiment of the invention assembled on the freehub portion of an embodiment of the bicycle rear hub, with a pawl and ratchet-ring clutch mechanism, at the pawl released position.

FIG. 5b shows the preferred embodiment of the invention assembled on the freehub portion of an embodiment of the bicycle rear hub, with a pawl and ratchet-ring clutch mechanism, at the pawl retracted position.

FIG. 6 shows partially exploded views of the different configurations of the preferred embodiment of the invention with a single or plurality of coiled members.

### DETAILED DESCRIPTION OF PREFERRED EMBODIMENT

The selected embodiment of a mechanical assembly to disengage a bicycle rear hub with a pawl and ratchet-ring clutch mechanism, described with the drawings, is provided for illustration only and is not meant to limit the invention as defined by the claims; where it can be susceptible to various changes and modifications without departing from the spirit of the invention.

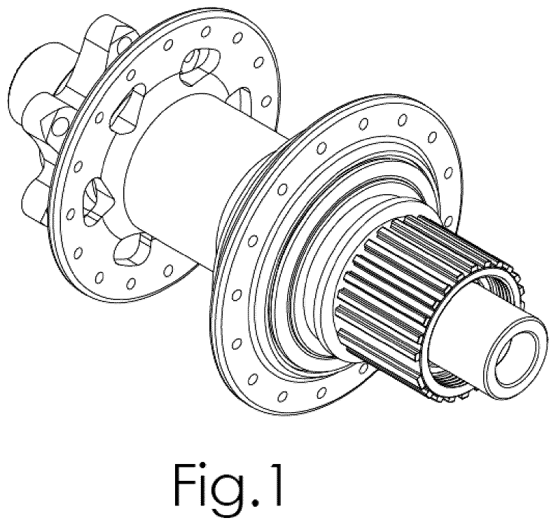

Referring first to FIG. 1, A typical embodiment of a bicycle rear hub is illustrated. The hub is attached to a rim by spokes, and with a tire mounted on the rim, they form the basic elements for a functional rear bicycle wheel that attaches to a bicycle frame.

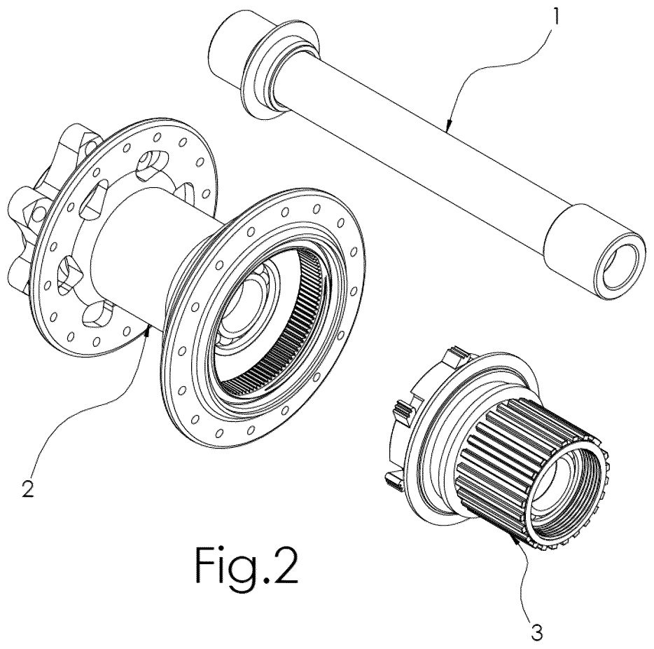

FIG. 2 shows the three component groups of an embodiment of a bicycle rear hub with a pawl and ratchet-ring clutch mechanism, separated by their main functions. The main axle 1 is axially and rotatably fixed to the bicycle frame, and stays stationary where it does not rotate relative to the ground and the bicycle frame. The axle 1 also serves as the common axis for all parts of the assembly, and its defined by the center line running through the length of the axle 1. The hubshell 2 contains all the components of the hub that are rotatably fixed to the wheel attached to the hub. The hubshell 2 is rotatably attached to the main axle 1 by means of bearings so that it is allowed to spin freely on the common axis from the main axle 1. The freehub 3 is where the drive-train of the bicycle attaches to the hub, having a singular or a plurality of cogs or sprockets attached on the exterior surface of the freehub 3. The freehub 3 contains all the components of the hub that are rotatably fixed to the drive-train attached to the hub. The freehub 3 is rotatably attached to the main axle 1 by means of bearings so that it is allowed to spin freely on the common axis from the main axle 1.

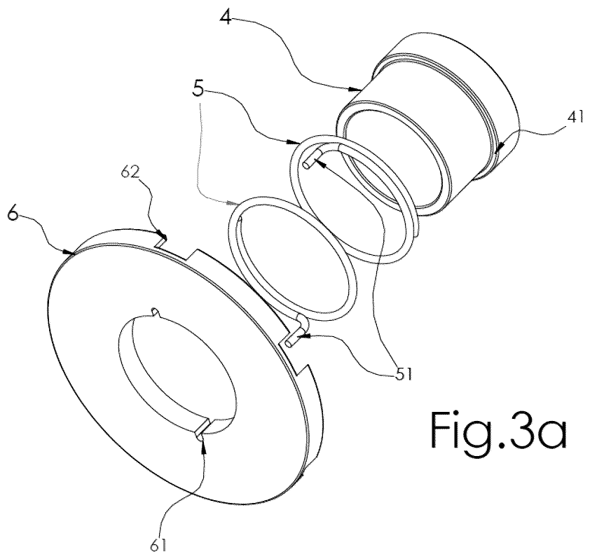

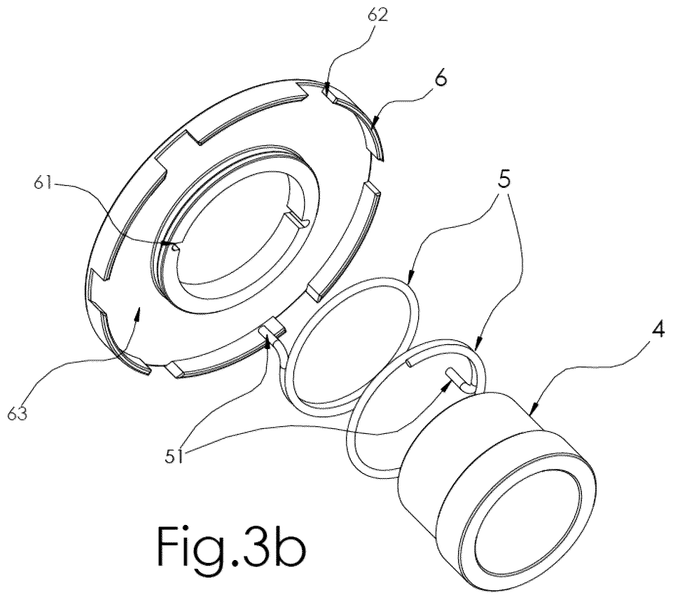

FIGS. 3a and 3b shows an exploded view of the components of the preferred embodiment of the invention, comprising of a sleeve or cylindrical member 4, which receives a single or plurality of coiled members 5 which are wound in series onto the cylindrical member 4 along its axial length, which is defined by the center line running through the length of the cylindrical member 4, where the coiled members 5 are supported by the shoulder 41 of the cylindrical member 4 from axially sliding further towards the shoulder 41 end of the cylindrical member 4. The coiled members 5 have a static fiction against rotation relative to the cylindrical member 4 in both directions. At the ends of the coiled members 5 furthest from the shoulder 41 of the cylindrical member 4, are protruding extensions 51 which have a length, an axis being defined by the center line running through the length of the protruding extensions 51, and the axis is parallel to the common axis. The protruding extensions 51 attach to a cam plate 6 by receiving slots 61 on the cam plate 6, where each receiving slot 61 corresponds to each protruding extension 51 of the coiled members 5, and these receiving slots 61 have a length, an axis being defined by the center line running through the length of the receiving slots 61, and the axis is in line with the axis of the protruding extensions 51. The protruding extensions 51 run an interference or slide fit onto the receiving slots 61, and trap the coiled members 5 between the shoulder 41 of the cylindrical member 4, and the inner face 63 of the cam plate, defined by the largest surface of the cam plate 6 facing the coiled members 5 and cylindrical member 4 with its surface plane perpendicular to the common axis. Disposed radially on the inner face 63 of the cam plate 6 are a plurality of slotted cams 62 which interact with the components of the freehub further explained on the next figures.

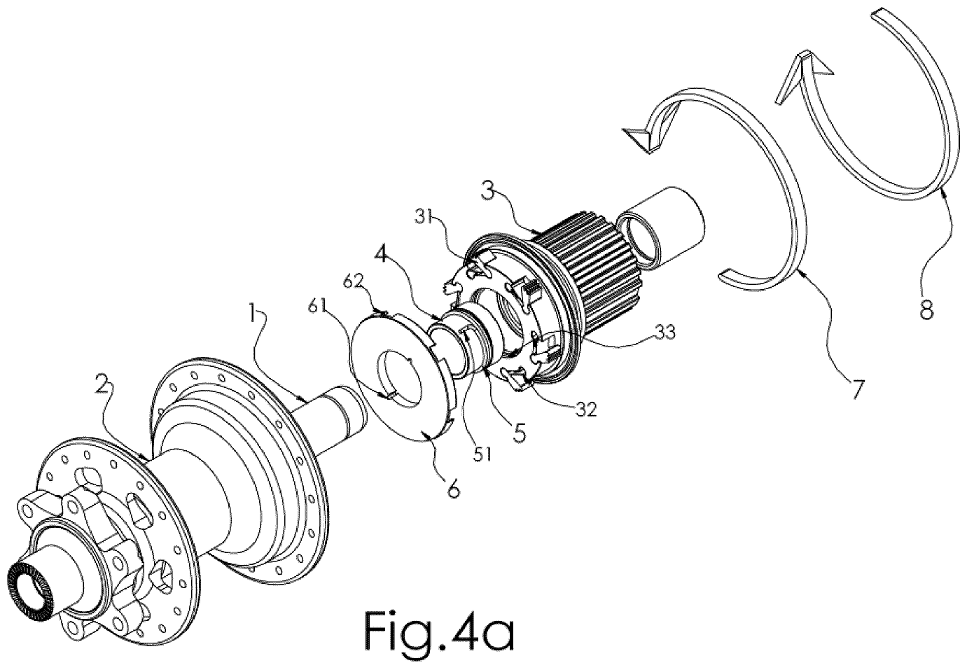

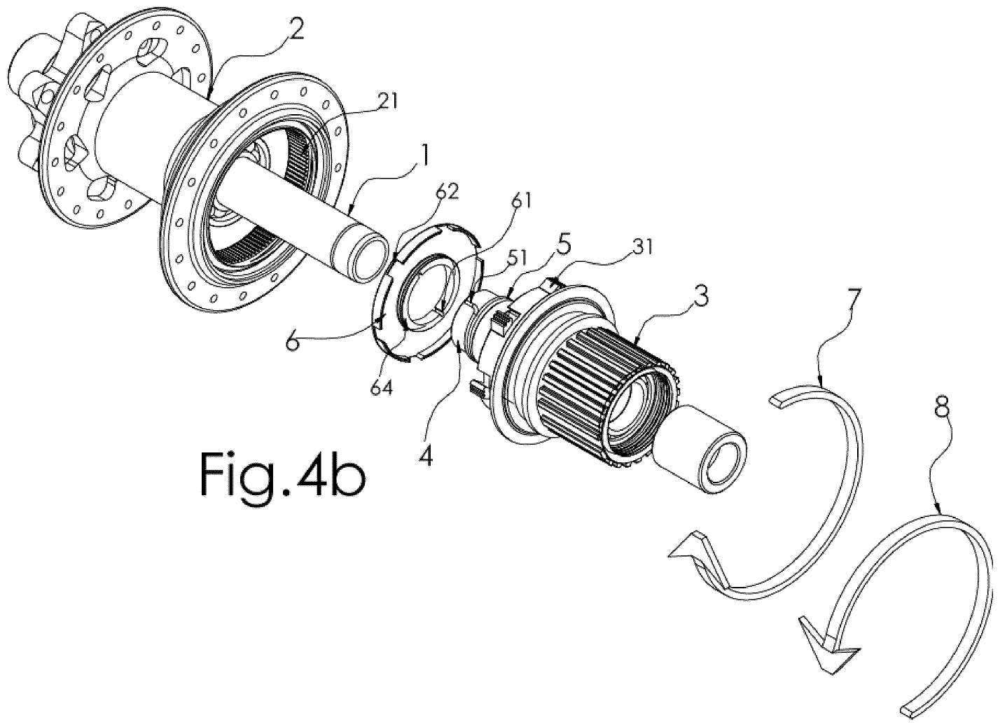

FIGS. 4a and 4b shows a partial exploded view of the components of the preferred embodiment of the invention within an embodiment of a bicycle rear hub with a pawl and ratchet-ring clutch mechanism. Where the embodiment of a bicycle rear hub with a pawl and ratchet-ring clutch mechanism operates by having one or a plurality of pawls 31, disposed rotationally on the freehub 3 along its axial length, defined by the center line running through the length of the freehub 3, each of the pawls 31 having a serration or teeth at one end, and a pivot point at the other end, and are sprung by their corresponding springs 32, which are also disposed rotationally on the freehub 3 along its axial length, and the springs 32 pivot the pawls 31 to extend their teeth end away from the axial length, so that the pawls 31 extend until in contact with the ratchet-ring 21 which is rotatably and axially attached to the hubshell 2. This ratchet-ring 21 has a plurality of serrations or teeth disposed rotationally at the inner surface of the ratchet-ring 21 along its axial length, defined by the center line running through the length of the ratchet-ring 21, and the teeth of the ratchet-ring 21 engage with the teeth of the pawls 31 so that in the direction of forward rotation 7 of the freehub 3 relative to the hubshell 2, there is a wedging interference between the pawls 31 and the ratchet-ring 21 so that the freehub 3 is not able to rotate forwards relative to the hubshell 2, with the resultant outcome of the freehub 3 driving the hubshell 2 in the direction of forward rotation 7 relative to the main axle 1. In the direction of backwards rotation of the freehub 3 relative to the hubshell 2, the teeth of the pawls 31 slide on the teeth of the ratchet-ring 21 by the reverse of the wedging geometry of the pawls 31 becoming a sloping geometry, so that by every tooth displacement between the pawls 31 and ratchet-ring 21, the pawls 31 toothed end retracts from the ratchet-ring 21, following by one ratchet sound from the springs 32 repositioning the pawls 31 toothed end back to the interference position, repeating this sequence for every next tooth displacement, with the resultant outcome of the freehub 3 being able to rotate in the direction of backwards rotation relative to the hubshell 2 without driving the hubshell 2. The relationship of the pawls 31 and the ratchet-ring 21 in this instance is the same to the instance where the hubshell 2 rotates in the direction of forward rotation 7 relative to the freehub 3 and the main axle 1. In the instance where the hubshell 2 rotates in the direction of reverse rotation 8 relative to the freehub 3, the interference between the pawls 31 and the ratchet-ring 21 will force the freehub 3 to rotate in the direction of reverse rotation 8 together with the hubshell 2.

The components of the preferred embodiment of the invention attach to the existing embodiment of a bicycle rear hub with a pawl and ratchet-ring clutch mechanism, by sliding the cylindrical member 4 that has the coiled members 5 wound onto the cylindrical member 4, onto the main axle 1 and into the freehub 3 cavity, so that the cylindrical member 4 is axially and rotatably fixed to the main axle 1 from the compression between the bearing components of the hubshell 2 and freehub 3 that rest on the main axle 1. The cam plate 6 attaches onto the freehub 3 by an annular snap joint formed between the freehub 3 grooved cavity 33 and the cam plate 6 cantilever ring protrusion 64. This annular snap joint allows the cam plate 6 to rotate relative to the freehub 3 at the common axis, but its rotation is limited by the interface between the slotted cams 62 and the pawls 31; where the slotted cams 62 form a cam-and-follower relation with the pawls 31. The protruding extensions 51 of the coiled members 5 penetrate the receiving slots 61 on the cam plate 6 by interference or sliding fit.

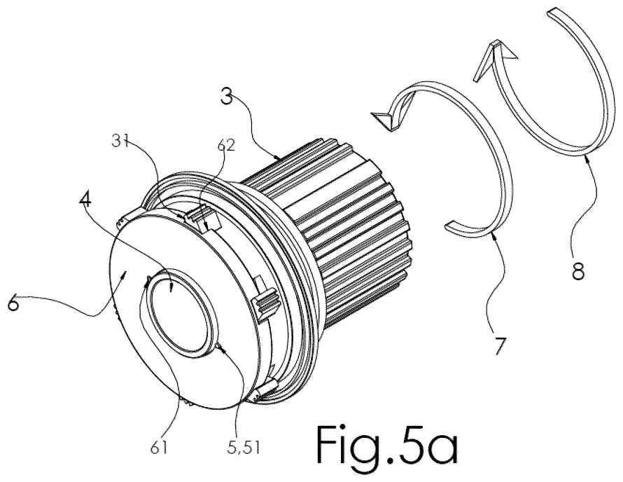

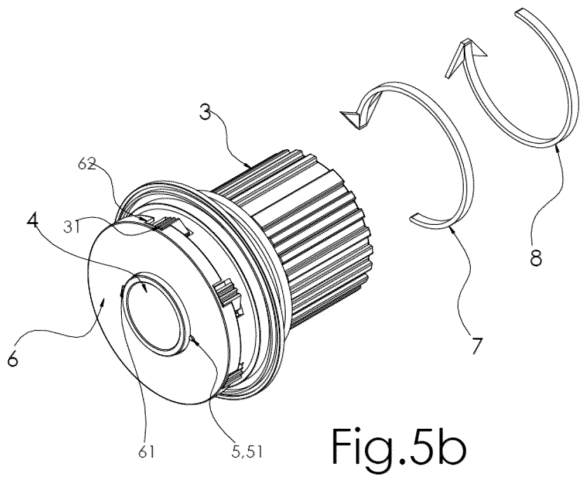

FIG. 5a shows the preferred embodiment of the invention assembled on the freehub 3 portion of an embodiment of the bicycle rear hub, where the proposed invention is positioned in the pawls 31 released position. In this position, when the freehub 3 is rotated in the direction of forwards rotation 7, the cam plate 6 is forced to rotate with the freehub 3 from the interference wedge between the slotted cams 62 and the pawls 31, and cam plate 6 rotates the coiled members 5 from the interference between the receiving slots 61 to the protruding extensions 51, overcoming the coiled members 5 static friction against rotation towards the cylindrical member 4, and sliding the coiled members 5 on the surface of cylindrical member 4, which is axially and rotatably fixed from the rest of the components.

FIG. 5b shows the preferred embodiment of the invention assembled on the freehub 3 portion of an embodiment of the bicycle rear hub, where the proposed invention is positioned in the pawls 31 retracted position. This position is reached from the pawls 31 released position when the freehub 3 is rotated in the direction of reverse rotation 8. During the initial reverse rotation motion of the freehub 3, the cam plate 6 is prevented from rotating with the freehub 3 by the static friction of the coiled members 5 against rotation towards the cylindrical member 4, transferred from the protruding extensions 51 to the receiving slots 61, where this static friction was re-introduced during the directional change of the freehub rotation, where momentarily during the directional change, the coiled members 5 stopped rotating in relation to the cylindrical member 4, or if the freehub 3 was rotatably stationary before initiating the rotation in the direction of reverse rotation 8. As the freehub 3 rotates relative to the cam plate 6, the sprung pawls 31 are forced to retract by following the slotted cams 62 interference to the sloping geometry of the pawls 31 until the pawls bottom out in their pivotal travel. Once the pawls 31 cant retract further, there is still an interference between the slotted cams 62 and the pawls 31 preventing further rotation of the freehub 3 relative to the cam plate 6, and the cam plate 6 starts to rotate together with the freehub 3 in the direction of reverse rotation 8, overcoming the static friction against rotation of the coiled members 5 towards the cylindrical member 4 through the interference between the receiving slots 61 to the protruding extensions 51, sliding the coiled members 5 on the surface of the cylindrical member 4.

When the freehub 3 is rotated in the direction of forwards rotation 7, from the pawls 31 retracted position, the cam plate 6 is prevented from rotating with the freehub 3 by the static friction of the coiled members 5 against rotation towards the cylindrical member 4, transferred from the protruding extensions 51 to the receiving slots 61, and as the freehub 3 rotates relative to the cam plate 6, the pawls 31 are released from the slotted cams 62 by following and extending through the opening of the slotted cams 62 aided by the pawls 31 sprung forces, until reaching the pawls 31 released position.

FIGS. 5a and 5b illustrate how the proposed invention actuates the pawls 31 in the freehub 3, based on the rotation direction of the freehub 3, where the direction of forwards rotation 7 does not interfere with the function of the embodiment of a bicycle rear hub with a pawl and ratchet-ring clutch mechanism, and the direction of reverse rotation 8 retracts the pawls 31 to rotatably decouple the freehub 3, with its attached drive-train, from any direction of rotation of the bicycle wheel attached to the rear hub; as well as preventing ratcheting during freewheeling.

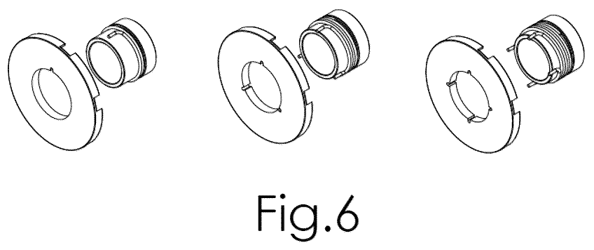

FIG. 6 illustrates various configurations of the embodiment of the coil members, where more than one coiled member and its corresponding protruding extensions and receiving slots are applicable. The coiled members can be coiled in series to allow the protruding extensions reach the receiving slots in an axially level fashion. The use of more coiled members disposed equally apart radially supplements the desired static friction needed to be overcome to initiate the rotation between the coiled members to the cylindrical member.

The invention shown in this embodiment described is not limited by the embodiment, and it should be apparent to those skilled in the art, that there invention is susceptible to changes and modifications without departing from the spirit of the invention, which are defined in the following claims.

I claim:

1. A mechanical assembly that integrates onto existing pawl and ratchet-ring bicycle rear hub clutch assemblies, which retract and release a plurality of pawls, comprising:
a cam plate, wherein the cam plate is a cylindrical end cap rotatably attached at a circular plane surface end of an existing cylindrical pawl carrier member, where this existing cylindrical pawl carrier member has the plurality of pawls radially disposed closest to this circular plane surface end, and the cam plate has overlapping capping extensions in the form of a plurality of slots that cap over this circular plane surface end of the existing cylindrical pawl carrier member along its length, and that the plurality of slots interact with the plurality of pawls of the existing cylindrical pawl carrier member in a cam and follower relation when the cam plate rotates relative to the existing cylindrical pawl carrier member at a common axis, this common axis defined by a center line running along the length of the existing cylindrical pawl carrier member, so that the edges that form the plurality of slots cause an interference to the plurality of pawls to retract them towards the common axis in one direction, and release the interference to the pawls in the opposite direction;
wherein each of the plurality of slots correspond to a single of the plurality of pawls from the existing cylindrical pawl carrier member, and a plurality of formed edges comprised from a longest dimension of the plurality of slots have an interference with the plurality of pawls that limits the rotation of the cam plate in relation to the existing cylindrical pawl carrier member at the end of the plurality of pawls movement from the cam and follower interaction between the plurality of slots to the plurality of pawls in any direction of rotation between the cam plate and the existing cylindrical pawl carrier member along the common axis;
wherein the cam plate has a hole running through the common axis, and at least one receiving slot forming at the edge of this hole, where the at least one receiving slot has a length, an axis of the at least one receiving slot being defined by a center line running through the length of this at least one receiving slot, and the axis of the at least one receiving slot is parallel to the common axis;
a cylindrical sleeve member, wherein the cylindrical sleeve member has a length, an axis of the cylindrical sleeve being defined by a center line running through its length, and the axis of the cylindrical sleeve coincides with the common axis;
wherein the cylindrical sleeve member has a raised shoulder at one of its ends, and the cylindrical sleeve member is rotatably fixed to the axis of the cylindrical sleeve, where it partially resides inside a bore at the circular plane surface end of the existing cylindrical pawl carrier member;
at least one coiled member, coiled to the cylindrical sleeve member, wherein the at least one coiled member has a friction against rotation over the cylindrical sleeve member, such that the friction is increased in a direction that wraps it more, and the friction is decreased in a direction that unwinds it, and the at least one coiled member is allowed to rotate relative to the cylindrical sleeve member once the friction is overcome in both directions;
wherein the at least one coiled member has a protruding extension at one of its ends, with the protruding extension having a length, an axis of the protruding extension being defined by a center line running through the length of the protruding extension, and the axis of the protruding extension is in parallel to the common axis;
wherein the protruding extension extends into the at least one receiving slot so that the at least one coiled member is rotatably fixed to the cam plate and is not allowed to rotate relative to the cam plate.

2. A method for retracting and releasing a plurality of pawls on a pawl and ratchet-ring clutch mechanism of a bicycle rear hub, comprising:
providing a cam plate rotatably attached to the circular plane surface end of an existing cylindrical pawl carrier member, with overlapping capping extensions forming a plurality of slots that overlap the plurality of pawls of the existing cylindrical pawl carrier member to actuate the plurality of pawls in a cam and follower manner from a rotation of the cam plate relative to the existing cylindrical pawl carrier member, that retracts the plurality of pawls into the existing cylindrical pawl carrier member in one direction and releases the plurality of pawls from its interference with the plurality of slots in the other direction, and the cam plate only rotates a specified degree relative to the existing cylindrical pawl carrier member before an interference between its capping extensions to the pawls prevents further rotation;
providing the cam plate and existing cylindrical pawl carrier member rotate relative to a cylindrical sleeve member featuring a raised shoulder, where the cylindrical sleeve member is attached to the cam plate by protruding extensions at one end of a at least one coiled member coiled onto the cylindrical sleeve member and resting against the raised shoulder, and the at least one coiled member has a friction against rotation towards the cylindrical sleeve member in both rotating directions;
rotating the existing cylindrical pawl carrier member in any direction relative to the cylindrical sleeve member results in the existing cylindrical pawl carrier member rotating relative to the cam plate, until the interference of the plurality of slots with the plurality of pawls at the end of the specified degree of rotation, stops the existing cylindrical pawl carrier member from rotating relative to the cam plate, where the cam plate forces the at least one coiled member to overcome the friction against rotation towards the cylindrical sleeve member through its attachment to the cam plate from their protruding extensions, so that the cam plate and the at least one coiled member rotate together with the existing cylindrical pawl carrier member relative to the cylindrical sleeve member;
Retracting and releasing the plurality of pawls of the existing cylindrical pawl carrier member depending on the rotation of the cam plate relative to the existing cylindrical pawl carrier member.
